(19) United States
(12) Patent Application Publication
(10) Pub. No.: US 2005/0229864 A1
(43) Pub. Date: Oct. 20, 2005

(54) Method for monitoring and controlling in real-time the non-consumed food in fish farms

(76) Inventors: Claudio Francisco Chanceaulme Willemsen, Puerto Montt (CL); Raul Hernan Alvarez Gatica, Puerto Montt (CL)

Correspondence Address: Finnegan, Henderson, Farabow,;Garrett & Dunner, L.L.P., 1300 I Street, N.W., Washington, DC, 20005-3315, US

(21) Appl. No.: 10/924,863

(22) Filed: Aug. 25, 2004

(30) Foreign Application Priority Data
Aug. 26, 2003 (CL) CL 1716-2003

(51) Int. Cl. A01K 61/00

(52) U.S. Cl. 119/230

(57) ABSTRACT

The invention is a method that, by processing captured images by means of a submarine camera (1) located inside a fish breeding cage (11) and under the mass of fish or feeding zone (12), allow to detect and quantify in real-time the non-consumed particles of food (13). The submarine camera (12) captures images that are sent (14)(15) to a computer (16), which, by means of a software, digitalizes and quantifies the particles in real-time, making alarms or actions when the number of particles reaches established patterns.

### SUMMARY

The invention is a method that, by processing captured images by means of a submarine camera (10) located inside a fish breeding cage (11) and under the mass of fish or feeding zone (12), allow to detect and quantify in real-time the non consumed particles of food (13). The submarine camera (10) captures images that are sent (14) (15) to a computer (16), which, by means of a software, digitalizes and quantifies the particles in real-time, making alarms or actions when the number of particles reaches established patterns.

### DESCRIPTION

One of the problems that characterizes the aquaculture is that the animals and plants involved in the farm are under the water, and the most of them can not be observed, unless by using special equipment and instrumentation.

In the case of the fish aquaculture, it is very difficult to verify in a visual and permanent way the amount of food that is consumed. The impossibility to verify the consumption in real-time originates two main problems: 1) the economic lost because of the food that is not consumed; and 2) the negative environmental impact that produces the wasted food.

The portion of food given to the fish is calculated in a theoretic way considering physical-chemistry parameters (temperature of water, amount of oxygen in the water, etc.), and biological parameters (age and size, etc.). In this calculation there are not considered other factors that may affect in a direct way the level of consumption of food by fish. For example, the stress caused by any activity related to the fish farm management may provoke that fish stop consuming food for many days. Another factor may be the time when fish get satisfied and stop consuming food. Both factors may be determined only by observation in real-time. Fish consume the food as long as it is dropped into the respective fish breeding cage, and in this process the fish must eat the pellets as long as they go downward through the water. The pellet that is not consumed, reach the bottom of the breeding cage and the environment and obviously became lost.

As a way of example, in the salmon farm related with the industrial scale, the food costs represents about the 60% of the total production costs. Therefore, the optimization in the use of the food may influence significantly the economic result of the company.

The invention introduced, comprises a system and a submarine camera located inside the cage under the big mass of fish arranged during the breeding process, providing a mean for observing the process of feeding and behavior of fish in real-time, in order to make the necessary changes in the proper time.

On the other hand, the invention provides a good mean for minimizing the negative environmental impact caused by the excess of food provided to the fish.

Besides, it can be used for controlling predators or other problems in the fish behavior. Even more, the invention is able to be used in any kind of fish farm in breeding raft-cages in which there is used mobile or static automatic or manual feeders, for feeding salmon, trout, croaker, sturgeon, carp, hake, sea bass, sea bream, tuna, eel and others.

Currently, in the prior art, in a PCT searching, under IPC classifications A01K 61/02 and G01N 023/223 there are described some methods for monitoring by means of acoustic sounding, based on the Doppler effect in order to detect the particles of food inside a determined perimeter, which uses sensors arranged inside and outside the raft-cage in which the fish are kept. The inconvenient of these systems is their low reliability in the interpretation of the acoustic sensor, because it may not discriminate another element from a food particle, and may present mistakes in their statistics because it quantify all the interferences inside its sweeping area.

PORO AB. uses a submarine camera for verifying the behavior and feeding of fish, focusing downward and using illumination systems in order to be able to observe the particles of food. The major inconvenient is that fish may be negatively affected by the illumination system.

Norcan Electrical Systems Inc. uses a submarine camera connected by a serial connection to a central feeding system. An operator is visually monitoring each raft-cage from a base station, making the necessary adjustments to the feeding system. A disadvantage in this case is that all the rafts are connected to the system, therefore the operator must verify one by one each raft-cage which makes difficult to activate properly and in the right time the feeding system.

In the prior art there is not disclosed any system able to capture images and quantifying in real-time the non consumed food particles, by means of a images processing system, which uses a submarine camera located under the mass of fish and that stops immediately the feeding of fish or decreases the related feeding rate when the assigned limit is exceeded.

### DESCRIPTION OF THE INVENTION

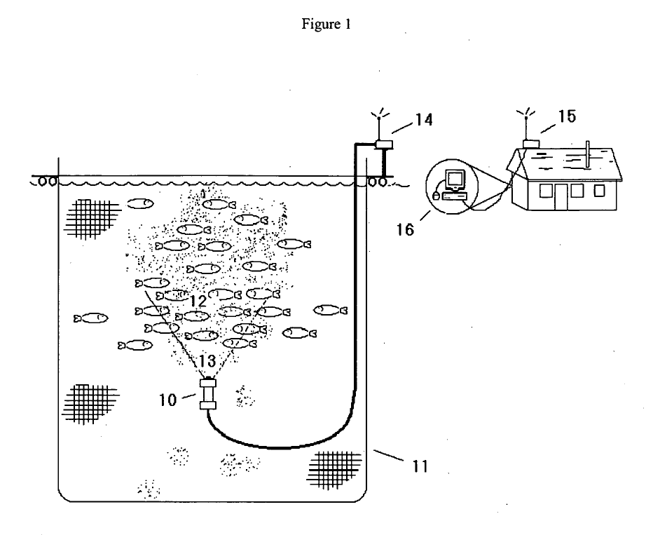

In FIG. 1 it is shown a submarine camera (10) located inside a fish breeding raft-cage (11) of any demersal species (i.e., the ones that swim and eat in the column of water) The submarine camera (10) must be located under the group of fish formed in the feeding zone (12) during the feeding process. Depending on the specie of fish, a skilled fish farmer will determine easily the best location for the submarine camera (10), generally near the center of the cage and between 4 and 12 meters depth.

The food is supplied in the top of the cage, and the fish (12) consume it as long as it gets inside the raft-cage (11) in which they are kept. The particles of food sink slowly through the column of water, therefore the images of the particles of non consumed food (13) may be easily captured by the submarine camera (10).

The submarine camera (10) may be any model able to satisfy the NTSC or PAL signal requirements, preferably one of the models Equa VISION, arranged preferably focusing upward or in the best possible arrangement for a better vision. In order to take the signal from the submarine camera (10) to the computer (16), it is used a wire connected to a conventional transmitter (14), located in the upper part of the raft-cage. This transmitter (14) transmits a signal to a conventional receiver (15), where the signal is received and sent to the computer (16) by means of a wire. A transmitter equipment that meets perfectly well the requirements is the module TRUP VISION.

The obtained signal of the submarine camera (10), is given to the system, by means of a image processing software, preferably the HALCON of MVTec GmbH, which controls the image acquisition card (frame grabber). A proper card according to the requirements of the present invention is one of the Falcon Family of IDS Imaging GmbH.

The food particles have a shape and texture relatively clear. By mathematical algorithms commonly used for determining shape and texture, the software discriminates the images of particles having certain characteristics respect to a predefined pattern.

The software programming characteristics are the following:

The imaging processing software takes an image and makes a grey scale spectrum analysis. By means of an algorithm of shape and texture there are determined all those shapes representing a food particle. Methods like this are well known for any skilled person in that technical field. Then, the captured image is analyzed is analyzed by the software by algorithms that determine, in real-time, the amount of particles of food that are passing through the feeding zone or that were not consumed by fish.

The system may display information in a graphic way, in a screen and may be integrated by an electronic interface with duplex communication, with the automatic feeding control software. It may export the information by internet and/or magnetic means, as well as it makes possible the data acquisition.

A skilled person in this area would know how to make a recognizing algorithm like the one mentioned above and the related equations in order to develop the software that provides the information in real-time of the number of particles over the predetermined limit values. For the same reason, the invention must not be limited by the specific algorithms used. On the contrary, the scope of the invention is to be limited only by the following claims.

1.- A method that uses images in real-time, for obtaining information of the non consumed particles of food by fish in fish breeding raft-cages CHARACTERIZED in that it comprises a submarine camera located inside the raft-cage, focused preferably upwardly, under the feeding zone of fish, in order to make images that are transmitted to a computer that, by means of a software acquire the images, interprets, analyzes and discriminates the food particles, quantifying them in real time making visual or sonorous alarms, that stops or reduces the feeding rate.

2.- A method that uses images in real-time, for obtaining information of the non consumed particles of food by fish in fish breeding raft-cages CHARACTERIZED in that it can control all the automatic feeding system.

3.- A method that uses images in real-time, for obtaining information of the non consumed particles of food by fish in fish breeding raft-cages CHARACTERIZED in that it can record the quantity of provided food making graphic reports.

4.- A method that uses images in real-time, for obtaining information of the non consumed particles of food by fish in fish breeding raft-cages CHARACTERIZED in that said reports can be exported by physical means and/or through the internet.
